(19) United States
(12) Patent Application Publication
(10) Pub. No.: US 2012/0226543 A1
(43) Pub. Date: Sep. 6, 2012

(54) ELECTRONIC GROUP COUPON RESELLING METHODS AND SYSTEMS

(76) Inventor: Venkat Dayala, St. Louis Park, MN (US)

(21) Appl. No.: 13/412,389

(22) Filed: Mar. 5, 2012

Related U.S. Application Data
(60) Provisional application No. 61/449,628, filed on Mar. 5, 2011.

(51) Int. Cl. G06Q 30/02

(52) U.S. Cl. 705/14.26

(57) ABSTRACT

The present disclosure relates generally to a system and method of reselling “group deal coupons” or “group buy coupons” using electronic methods (such as through a computer software application) and non-electronic methods. The reselling process can include electronic devices, networking equipment capable of transmitting data packets to and from the seller, buyer, main operations hub and any required verifications data centers. The transaction can consist of electronic exchange and display of coupons to be sold, terms and conditions to buy including the price, taxes and charges.

### RELATED APPLICATIONS

This application relates to U.S. Patent Application Ser. No. 61/449,628, filed on Mar. 5, 2011, titled ELECTRONIC GROUP COUPON RESELLING METHODS AND SYSTEMS, which is hereby incorporated by reference in its entirety.

### BACKGROUND OF INVENTION

Group coupons, or coupons issued by “group deal” companies on behalf of their clients, typically offer for sale an electronic coupon that can be printed and used by a purchaser within a given expiration period. For example, a coupon may be issued by a group deal company (e.g., Groupon or LivingSocial) which can be purchased for half the face value of that coupon if a sufficient number of individuals commit to purchase that group coupon. Vendors, or companies issuing those group coupons, typically make a commission reflected as a portion of the money paid for the group coupon. Clients, or companies offering the incentive and the places of redemption of the group coupons, also receive some money from sale of the group coupon. Customers must pay the cost of the coupon, regardless of whether they later will or will not be able to take advantage of the offer.

Coupons initially issued by “group coupon” companies have an expiry date by which they have to be used. An individual may buy these coupons by paying the buying price in advance to the “group coupon” companies. This paid amount is often non-refundable, and cannot be returned or exchanged for money or any other coupons of interest. Often, an individual who paid upfront for a group coupon cannot use that coupon due to later-arising scheduling conflicts, developed disinterest, or simply to attempt to profit from the perceived value of the group coupon. Furthermore, individuals wishing to buy a group coupon might miss the opportunity to buy the coupons of their interest due to circumstance or choice.

Currently there is no method or service in place to be able to resell any unused coupons before the expiry date of the coupon. Also, no service or method exists to facilitate the purchase of coupons after the offer date of the coupon for sale while reducing likelihood of fraud or scams.

There is no platform to bring the buyers and seller of the coupons together electronically over a network with exchange of data packets or conventionally to be able to perform a safe ecommerce transaction. There is also no one-stop shop service available to allow purchasers to look at coupons offered by multiple coupon sellers and to buy coupons using one unified account at one location, rather than holding multiple accounts for every individual coupon-selling company (i.e., the “group coupon” companies or vendors.)

For these and other reasons, improvements are desirable.

### SUMMARY OF INVENTION

The present disclosure relates to a low cost way to resell undesired and unused group coupons using a communications device. The communications device can be, for example, a computer, cell phone, PDA, tablet device, or other electronic communications device using a network such as the internet, Wi-Fi, a cellular network or other networking infrastructure. The present disclosure also relates to creating a marketplace for reselling group coupons, including means for posting a group coupon for sale, means for searching for a group coupon offer for sale, and means for purchasing group coupons offered for resale. In some embodiments, an auction marketplace is created in which a fair initial price can be established, with auction bidding implemented to maximize the resale price of the group coupon.

In some embodiments, the present disclosure relates to methods and systems for tracking sale and purchase of group coupons offered for resale, as well as infrastructure and algorithms for managing resale, such as by using various e-commerce tools (e.g., PayPal or other online payment systems, or credit card/debit systems).

In further embodiments, the present disclosure relates to communication systems allowing purchasers and sellers to communicate with each other to facilitate the transfer of a group coupon. Interest in group coupons can also be archived and monitored for a given period of time, without creating any obligation to buy or sell the group coupon on the part of contacting party.

In connection with the above, methods and systems are included for validating the authenticity and value of the group coupon, as well as to keep track of an individual or enterprises group coupon bought and sold over a period of time. Accordingly, all group coupon resale transactions and activities can be recorded when the methods and systems of the present disclosure are utilized.

### BRIEF DESCRIPTION OF THE DRAWINGS

FIG. 1 illustrates an example network in one embodiment of the present invention, in which methods and systems for reselling group coupons can be implemented;

FIG. 2 illustrates an example data flow within the network of FIG. 1;

FIGS. 3-4 illustrate a flowchart of methods and systems for reselling a group coupon, according to one possible embodiment;

FIG. 5 illustrates a flowchart of methods and systems for registering a user for purchasing or reselling a group coupon, according to a possible embodiment;

FIG. 6 illustrates a flowchart of methods and systems for logging a user in to a system for reselling group coupons, according to a possible embodiment;

FIGS. 7-8 illustrate a flowchart of methods and systems for purchasing a resold group coupon, according to one possible embodiment;

FIG. 9 illustrates a flowchart of methods and systems for verifying validity of one or more group coupons, according to a possible embodiment;

FIG. 10 illustrates a flowchart of methods and systems for updating coupon codes upon resale or other transfer of a group coupon, according to a possible embodiment.

FIG. 11A is a flowchart of example methods and systems for maintaining the redemption and validity status of a group coupon, according to a possible embodiment;

FIG. 11B is a flowchart of methods and systems for determining, by a customer, the redemption and validity status of a group coupon managed using the methods and systems of FIG. 11A;

FIG. 12 is a flowchart of methods and systems for establishing a hold on a group coupon, according to a possible embodiment;

FIG. 13A illustrates customer action for a “spy buy” process in which a customer can elect to be alerted and can purchase group coupons redeemable at particular clients, and offered by other users;

FIG. 13B illustrates operation of the system to implement the “spy buy” process of FIG. 13A;

FIG. 14 illustrates an example of a user interface screen capable of being generated using the methods and systems of the present disclosure, in one embodiment of the present invention.

FIG. 15 illustrates a further example of a user interface screen capable of being generated using the methods and systems of the present disclosure, in one embodiment of the present invention.

FIG. 16 illustrates a further example of a user interface screen capable of being generated using the methods and systems of the present disclosure, in one embodiment of the present invention.

FIG. 17 illustrates a further example of a user interface screen capable of being generated using the methods and systems of the present disclosure, in one embodiment of the present invention.

FIG. 18 illustrates a further example of a user interface screen capable of being generated using the methods and systems of the present disclosure, in one embodiment of the present invention.

FIG. 19 illustrates a further example of a user interface screen capable of being generated using the methods and systems of the present disclosure, in one embodiment of the present invention.

FIG. 20 illustrates a further example of a user interface screen capable of being generated using the methods and systems of the present disclosure, in one embodiment of the present invention.

FIG. 21 illustrates a further example of a user interface screen capable of being generated using the methods and systems of the present disclosure, in one embodiment of the present invention.

### DETAILED DESCRIPTION OF THE PREFERRED EMBODIMENT

The present disclosure relates generally to a system and method of reselling “group deal coupons” or “group buy coupons” using electronic methods (such as through a computer software application) and non-electronic methods. The coupons considered are unused and valid, and hold the full or partial value as declared by the initial seller of the coupon, e.g., Crowd Cut, LivingSocial, Groupon, etc. (an individual can be initial seller if he is selling a coupon that is bought by using the methods and systems disclosed herein, as sold through some other individual). In the context of the present disclosure, a user of the system could be one or more of a client (a company or retailer at which a group coupon can be redeemed) or a customer, including both a reseller of a group coupon and a prospective buyer of a group coupon.

The reselling process can include electronic devices, networking equipment capable of transmitting data packets to and from the seller, buyer, main operations hub and any required verifications data centers. The transaction can consist of electronic exchange and display of coupons to be sold, terms and conditions to buy including the price, taxes and charges. An individual will be identified as a customer or a client depending on the interest of selling or buying a coupon.

The individual will go through authorization process that will further facilitate him/her to buy and sell coupons, such as the “group deal coupons”, as desired. During this purchase and sale process, the system will initiate an action to verify the validity of the coupon to be sold to buyers. This process can include a number of internal and external validation steps, and can be performed using a computing system, such as over the electronic network though exchange of data packets and can also include manual verification system through more conventional method of phone call, telegraph, mail.

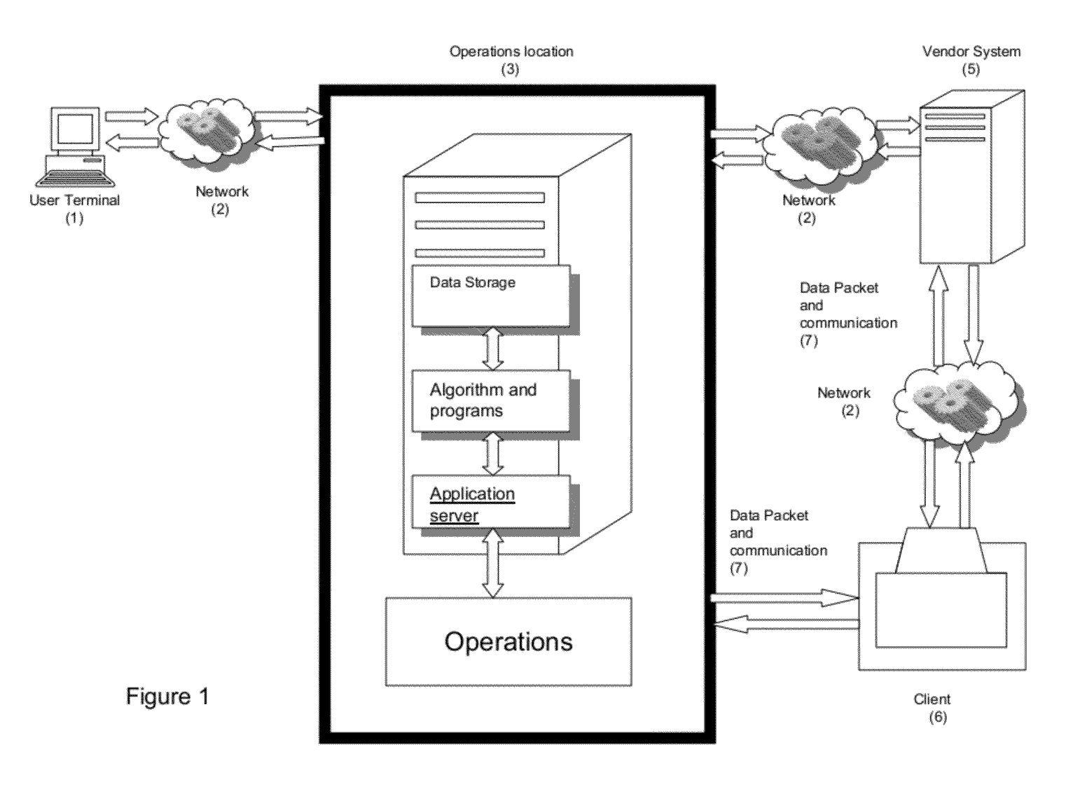

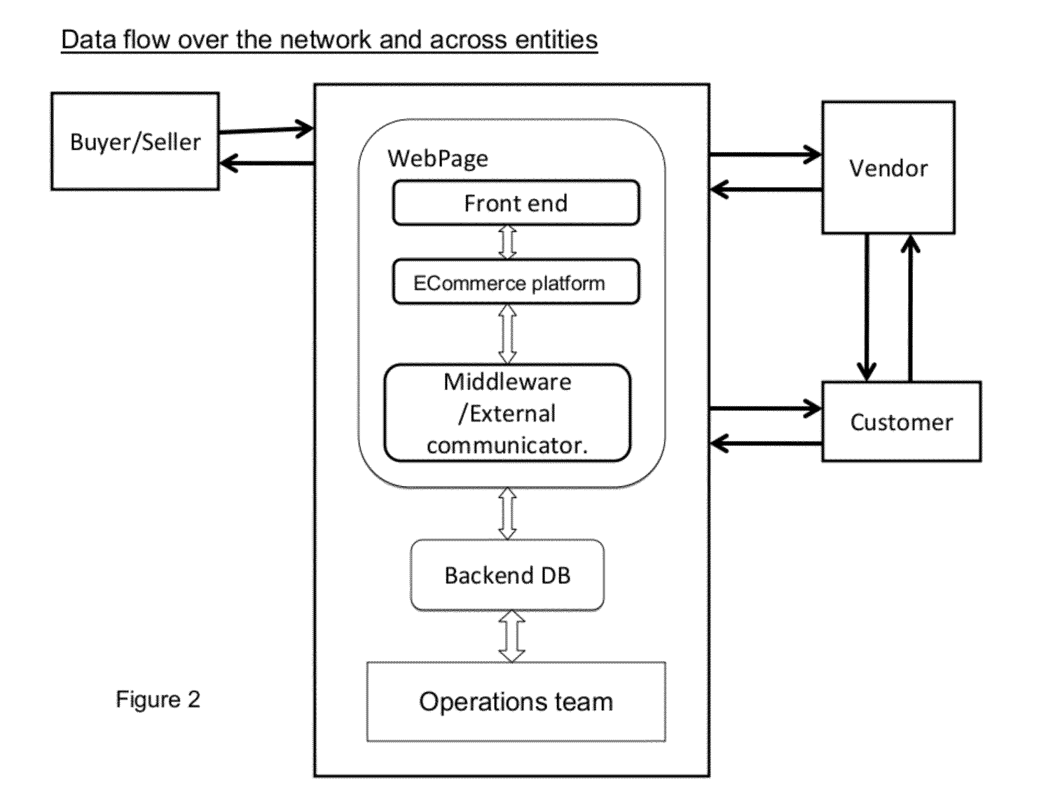

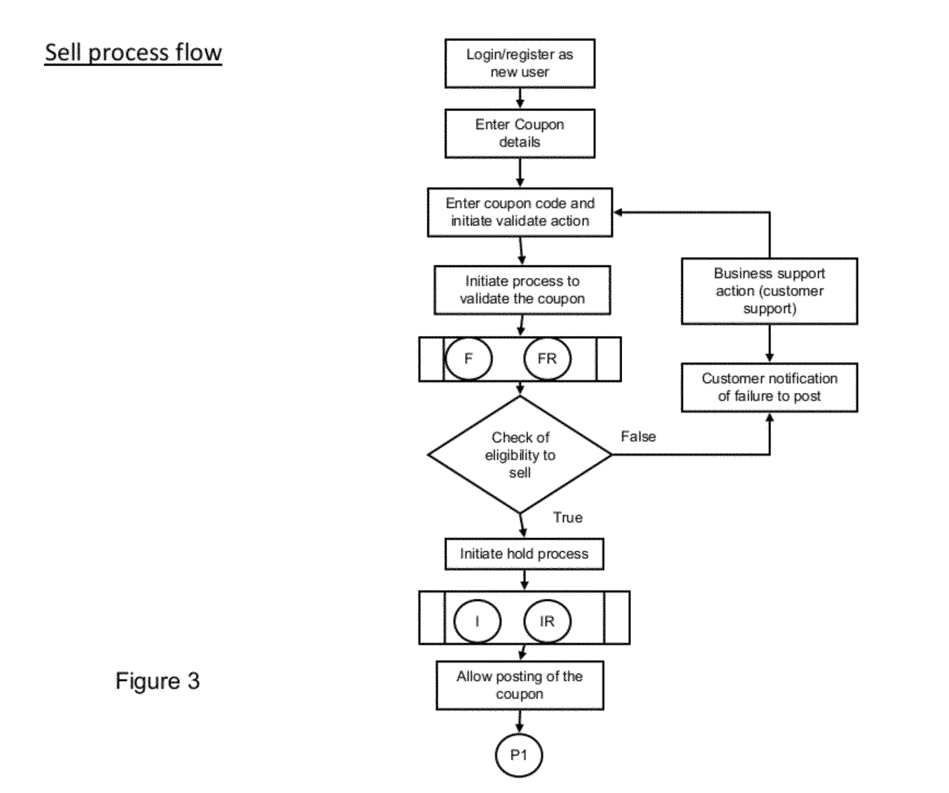

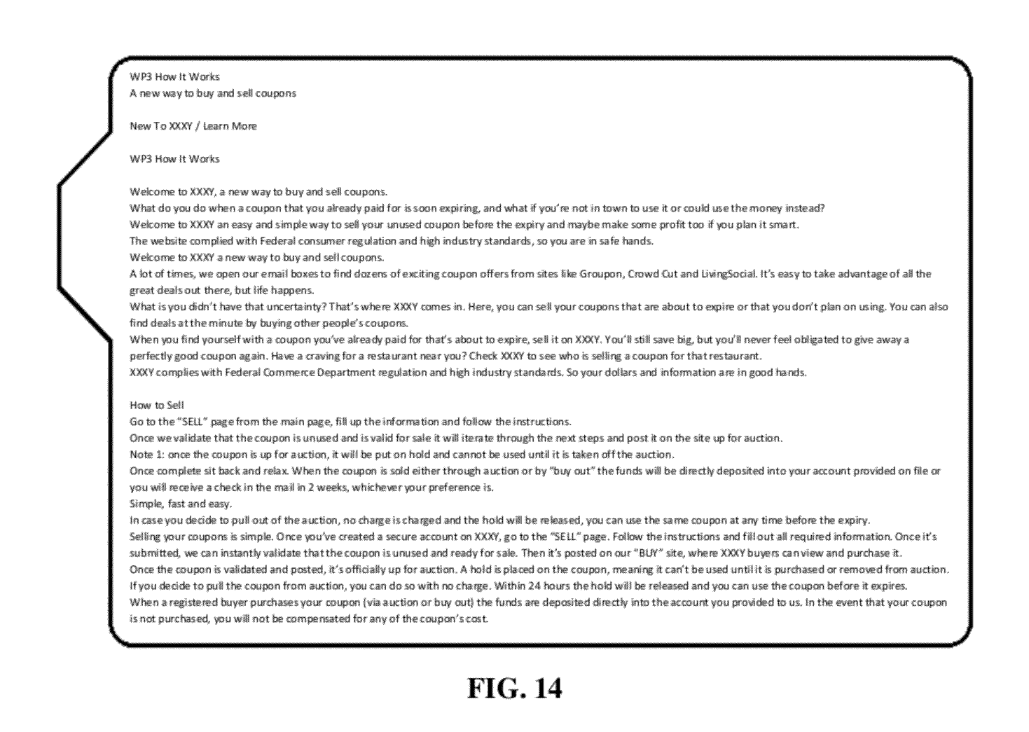

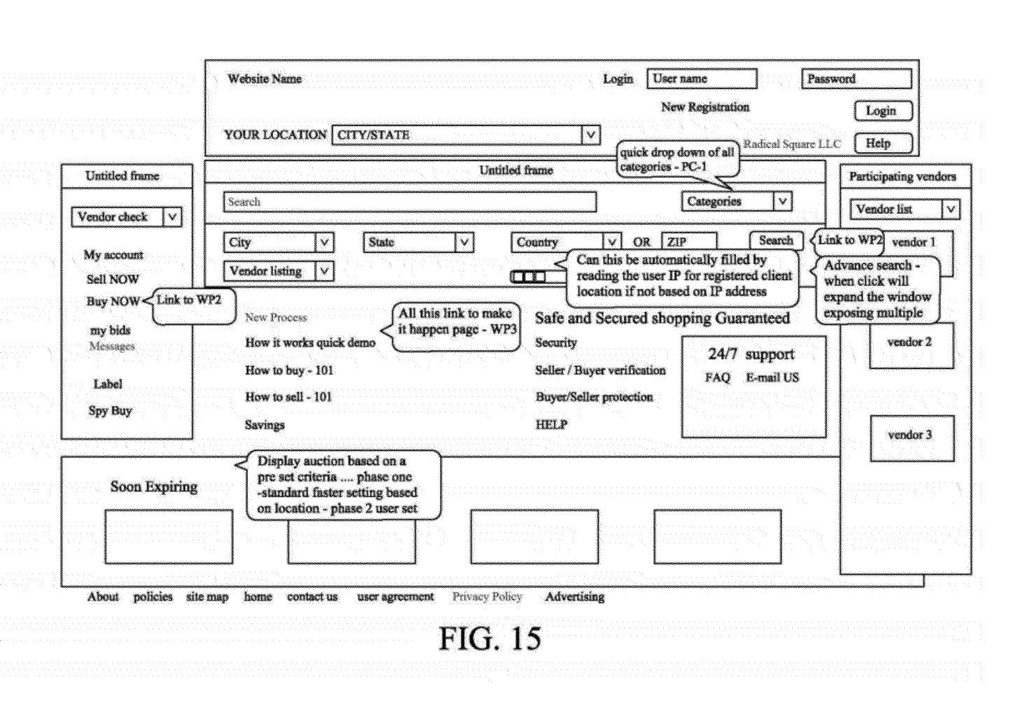

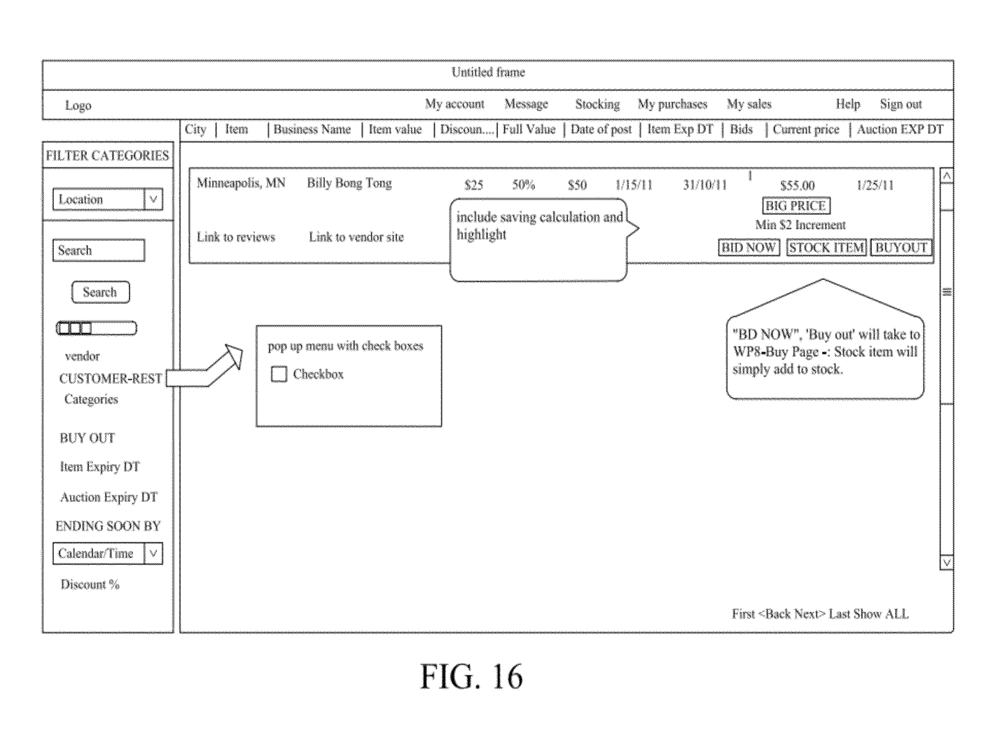

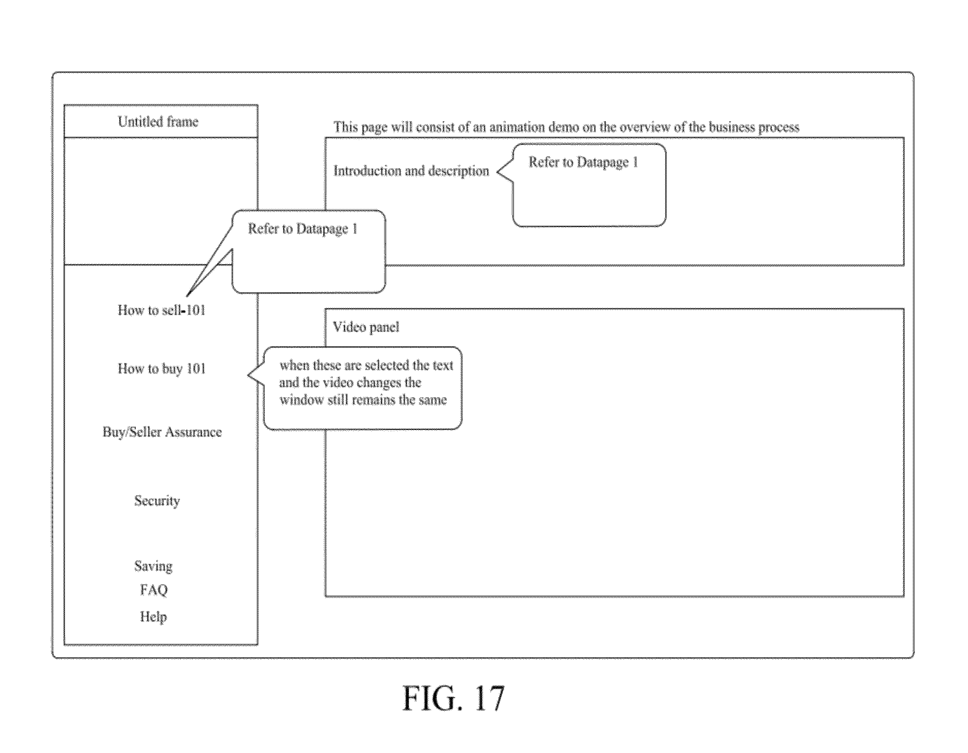

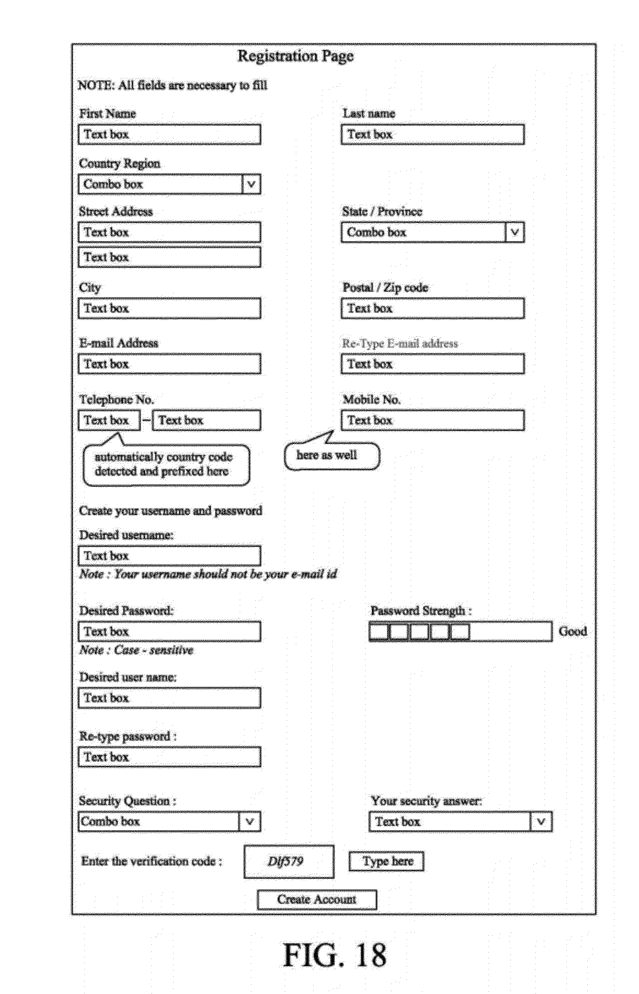

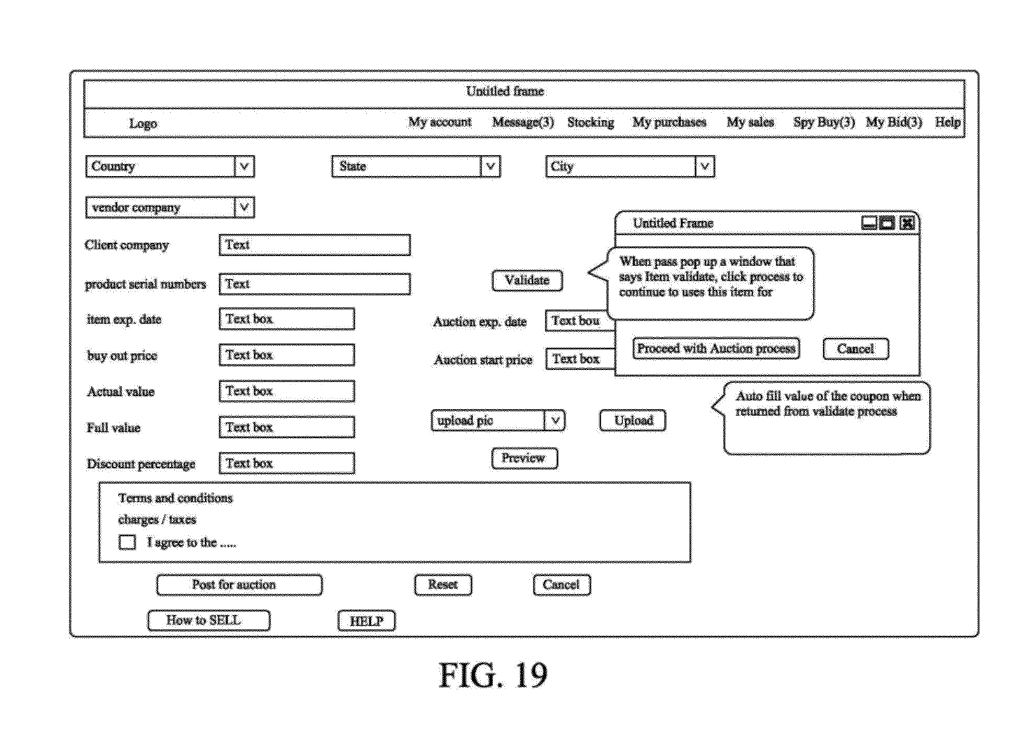

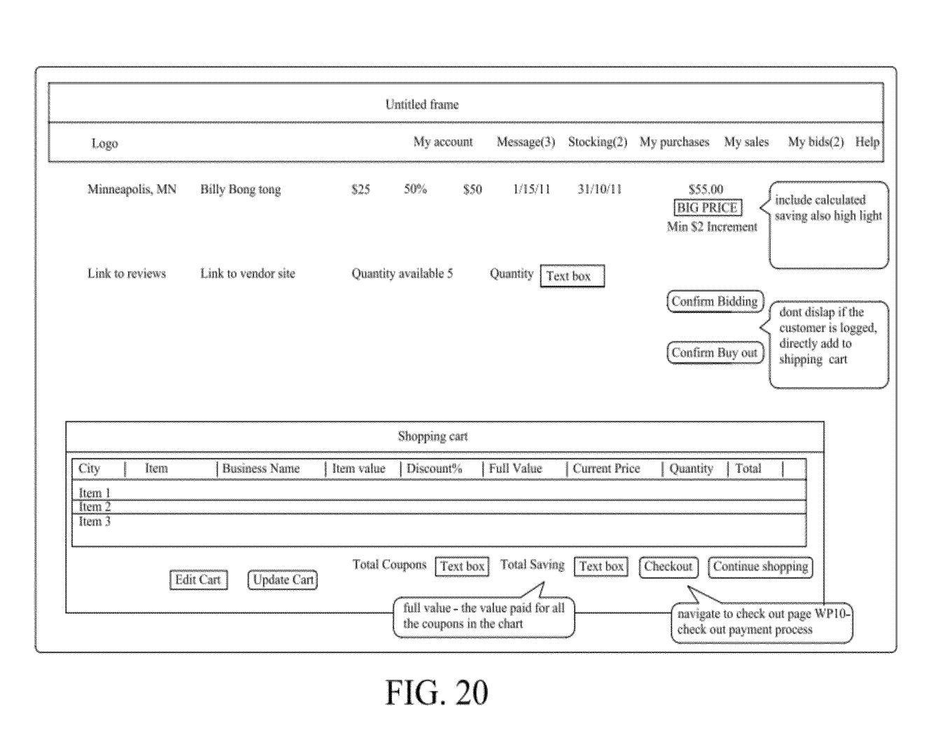

Referring to the Figures, FIGS. 1-2 illustrate an example network in which embodiments of the present disclosure can be employed. Generally, an operations location can provide a service between a user terminal (at which a buyer can reside), and both a vendor (a group coupon issuer) and a client (a group coupon redeemer). The operations location can store data and application programs to implement the flowcharts of FIGS. 3-13, and generate the user interface screens of FIGS. 14-21 (e.g., via the web server illustrated in FIG. 2).

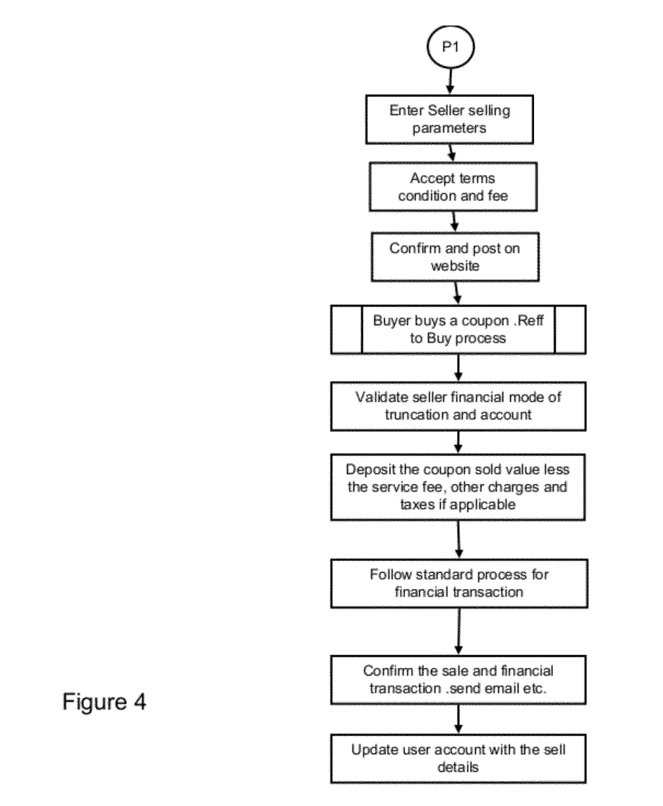

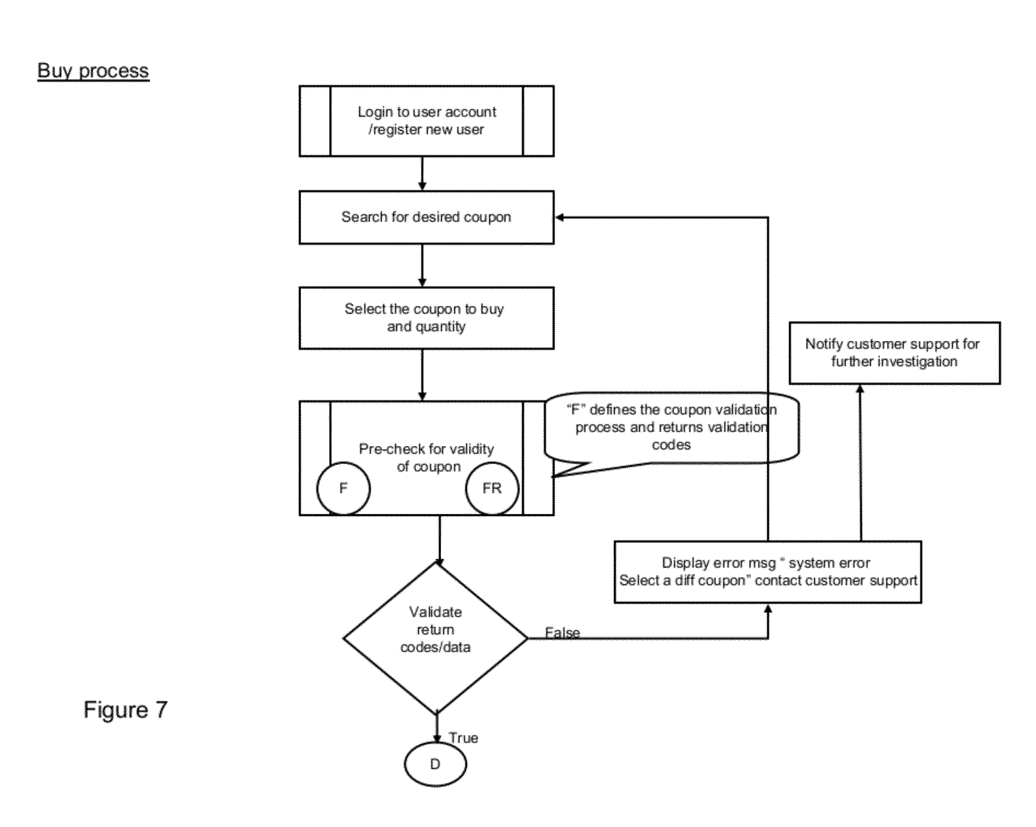

FIGS. 3-4 illustrate a flowchart of methods and systems for reselling a group coupon, according to one possible embodiment. Generally, a user will register with the group coupon reselling system (e.g., using the registration process outlined in FIG. 5), and will enter the details of the group coupon. The coupon code is entered and verified as authorized (e.g., using the methods and systems outlined in FIG. 9). After the coupon is offered for sale, it can be placed on hold so that a seller cannot both use and sell the same group coupon. When a sale occurs (e.g., via a hard price or auction process), the coupon codes are updated with relevant entities and both user accounts are updated to reflect the transaction.

As illustrated in further detail in the registration process of FIG. 5, a user will enter user information and create new user credentials. An account for that user can be created, after which that user can purchase or resell group coupons using the methods and systems disclosed herein.

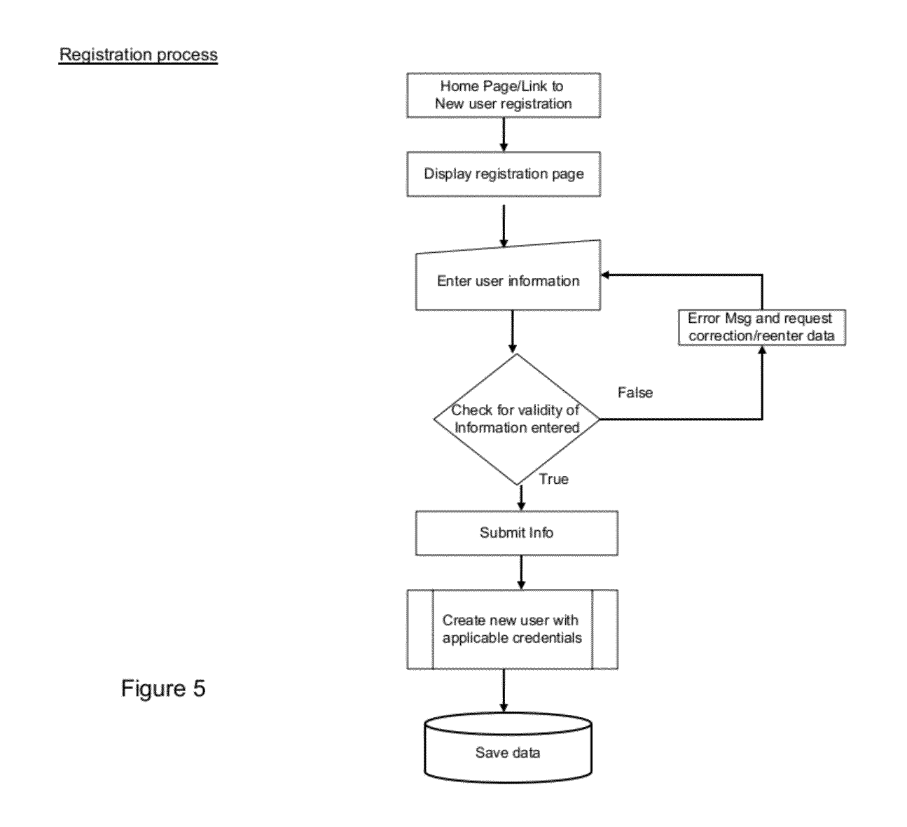

As illustrated in FIG. 6, a registered user can enter his or her user credentials (typically a username and password), which are then verified. That user can then be taken to a home page in which he/she can access his or her group coupon purchase and sale history and messages that user may have exchanged with other prospective purchasers and sellers.

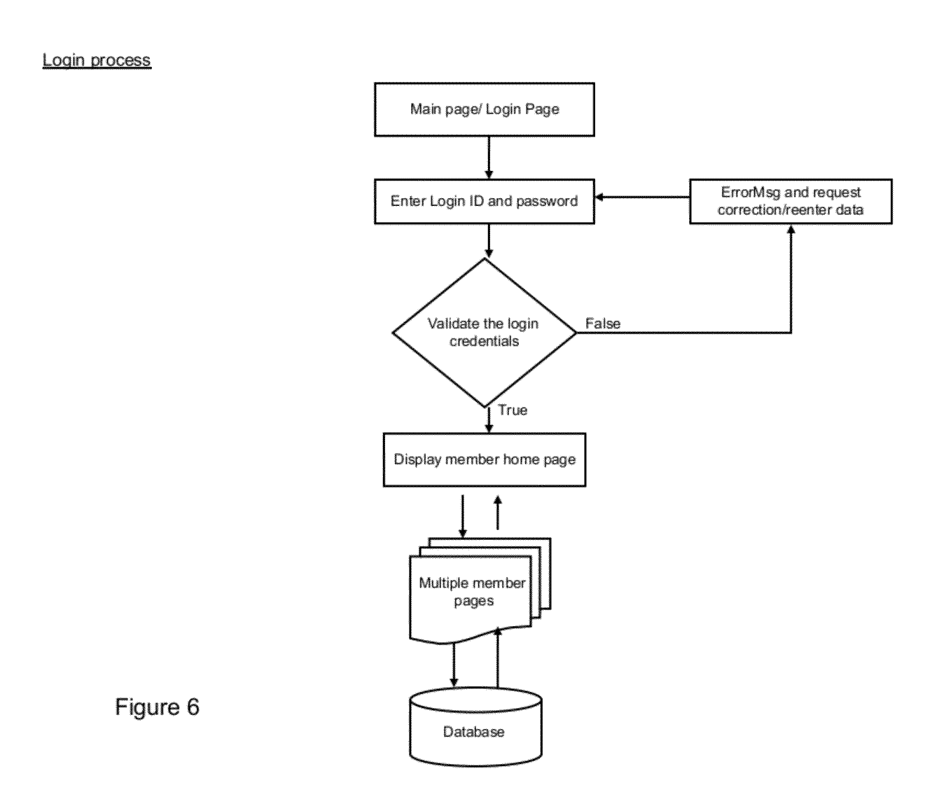

During a group coupon buy process as illustrated in FIGS. 7-8, a user will log in to the group coupon resale system, and search for a desired coupon (e.g., by business, by discount amount, or by other criteria), and select a quantity of the coupon to buy. The system will locate coupons matching that description, and return applicable results. The results are validated as currently-available group coupons prior to display to that user. The user can elect to bid on or buy the coupon for a particular price. Once a price is agreed on, a new coupon code is generated to represent the coupon as it is held by the new resale purchaser. The record for the coupon is updated within the present system, as well as in the system of a vendor or customer system, or other systems controlled by entities monitoring group coupon information. The new coupon is created and sent to the resale purchaser.

As illustrated in FIG. 9, a variety of types of group coupon verification processes can occur to ensure that the group coupon has not yet been used by the prospective reseller. These various types of coupon validation steps depend in part on which entity is tracking the owner of the group coupon. It is recognized that one or more of the process flows of FIG. 9 could be used for a single group coupon, or a plurality of group coupons.

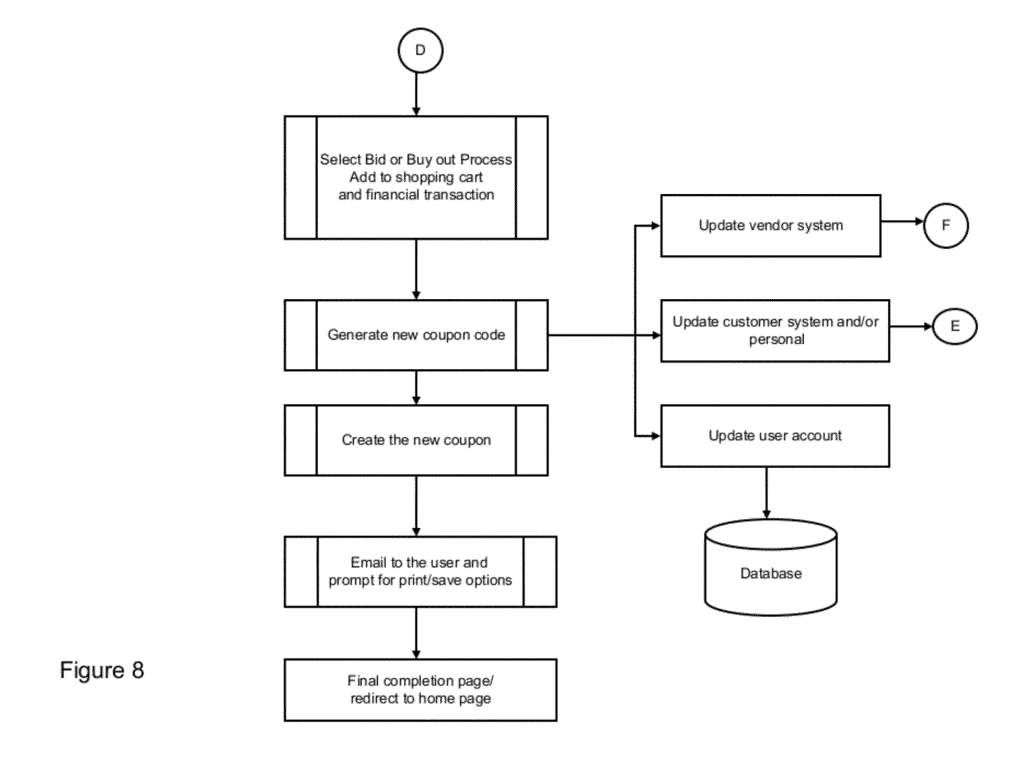

As illustrated in FIG. 10, when a group coupon is resold, a new code is associated with that group coupon at every entity that tracks that coupon and for which updating is necessary to either (1) allow the resale purchaser to redeem the group coupon or (2) prevent the reseller from redeeming the original coupon after sale.

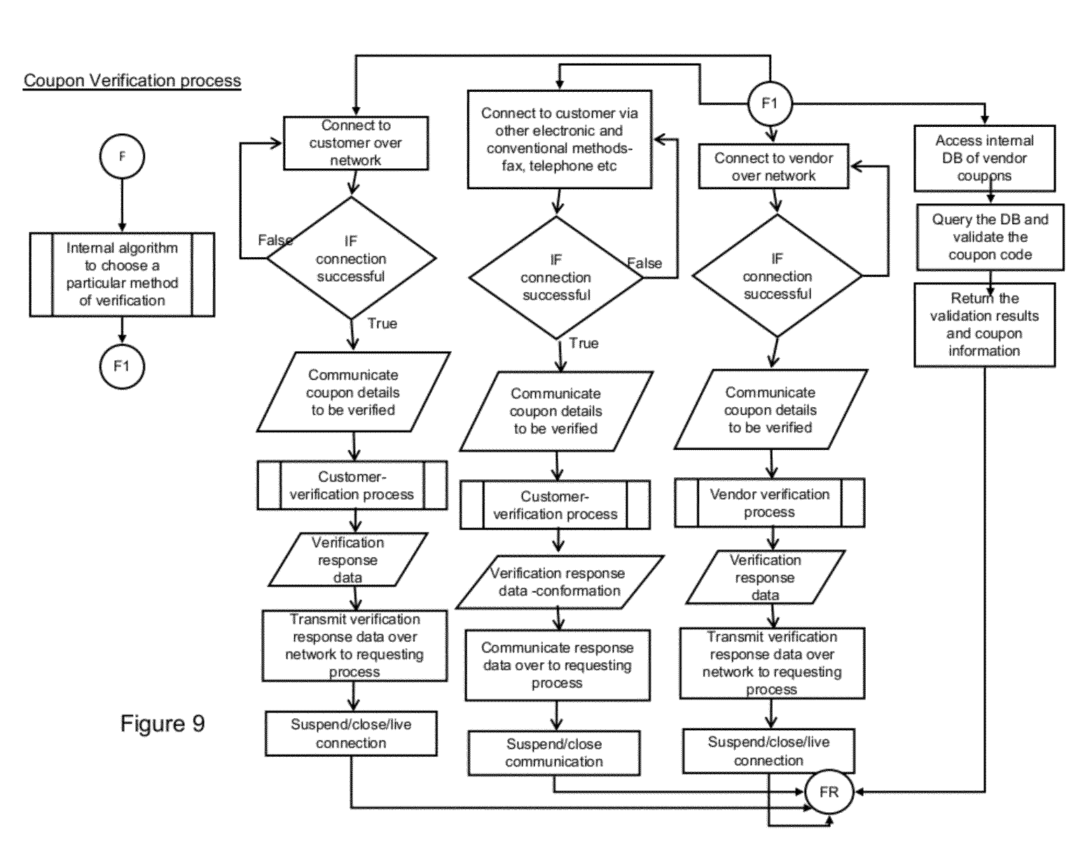

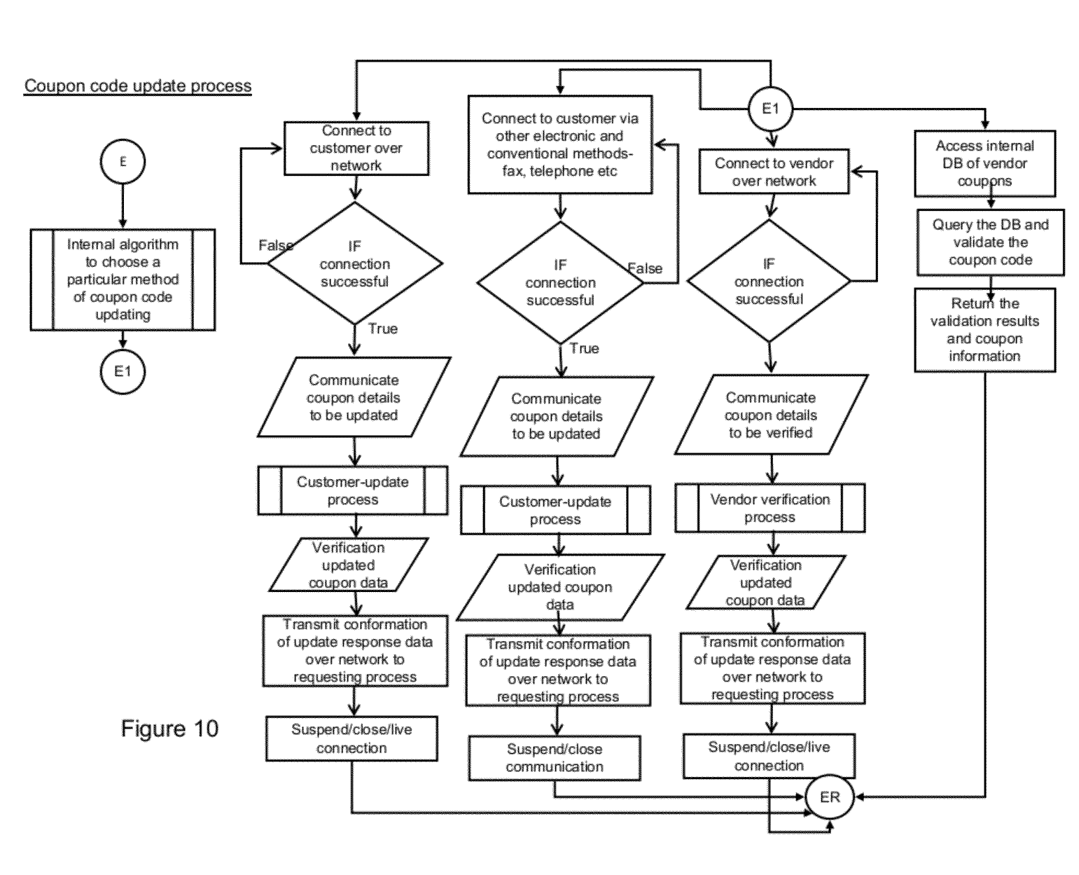

FIG. 11A is a flowchart of methods and systems for maintaining the redemption and validity status of a group coupon, according to a possible embodiment. Generally, the system will periodically refresh its data from a group coupon vendor to ensure it has an up-to-date set of group coupon information stored in the database of the present system. FIG. 11B illustrates an example system in which a user of a group coupon, for example a resale purchaser of a group coupon, can use a web-based, phone-based, or other communication interface to request a validation message relating to the group coupon prior to use. Clients (e.g., restaurant owners or any other issuing retailers) use the systems disclosed herein to maintain the coupon status, which include checking and updating the status of a group coupon. This method can be used by coupon owners (potential customers) to only check (not update) the status of the coupon.

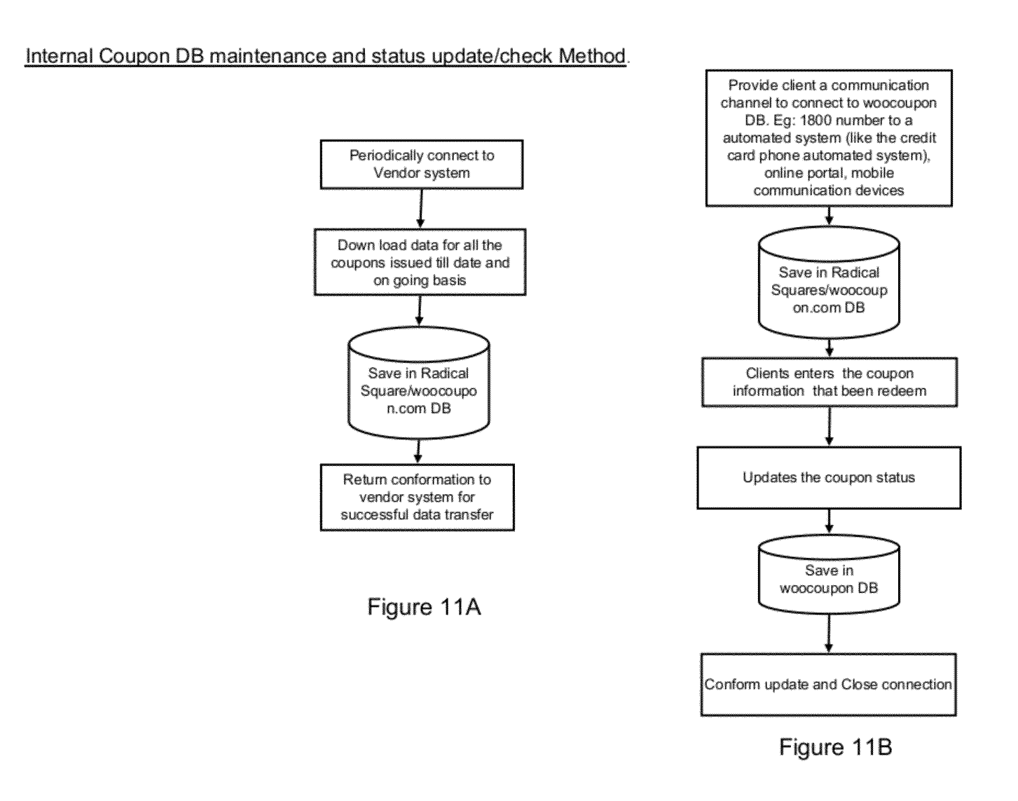

FIG. 12 illustrates how a group coupon hold process is implemented. The hold process occurs when a group coupon reseller offers his/her group coupon for sale. While the group coupon is offered for sale, the group coupon should not be able to be used by the reseller, thereby preventing that reseller from using and selling the same group coupon.

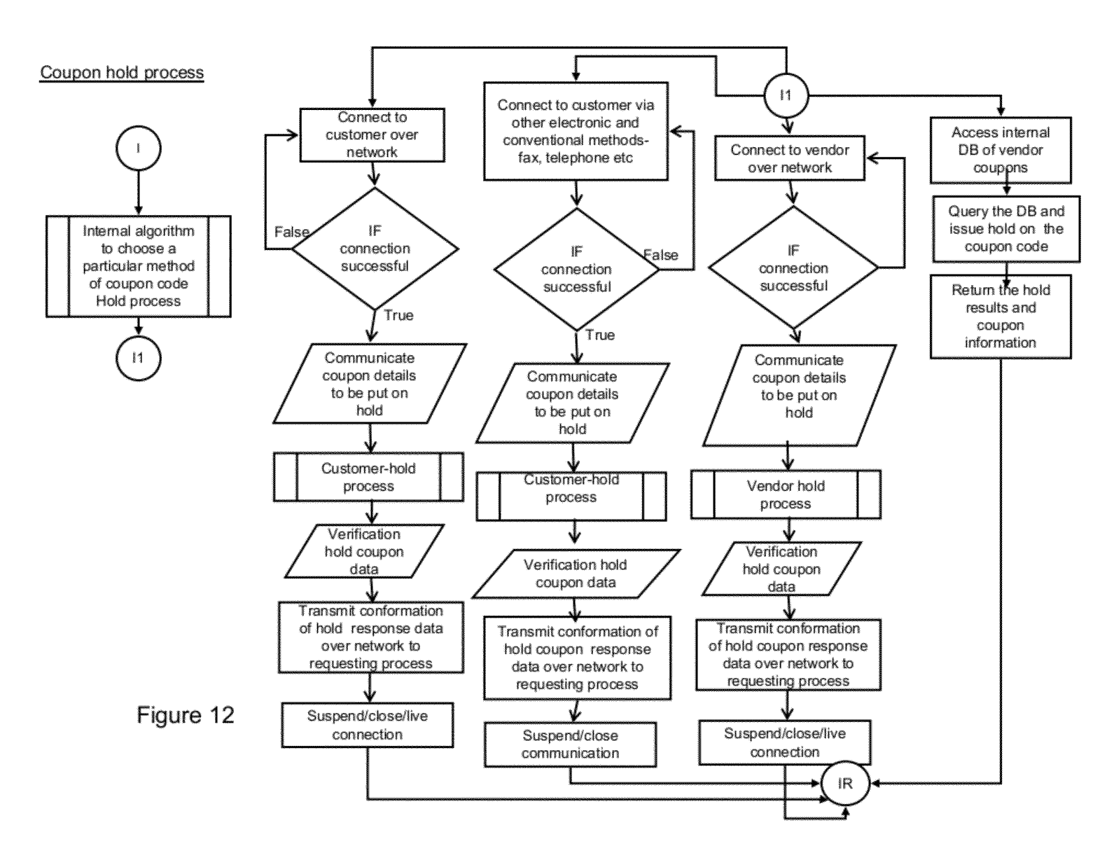

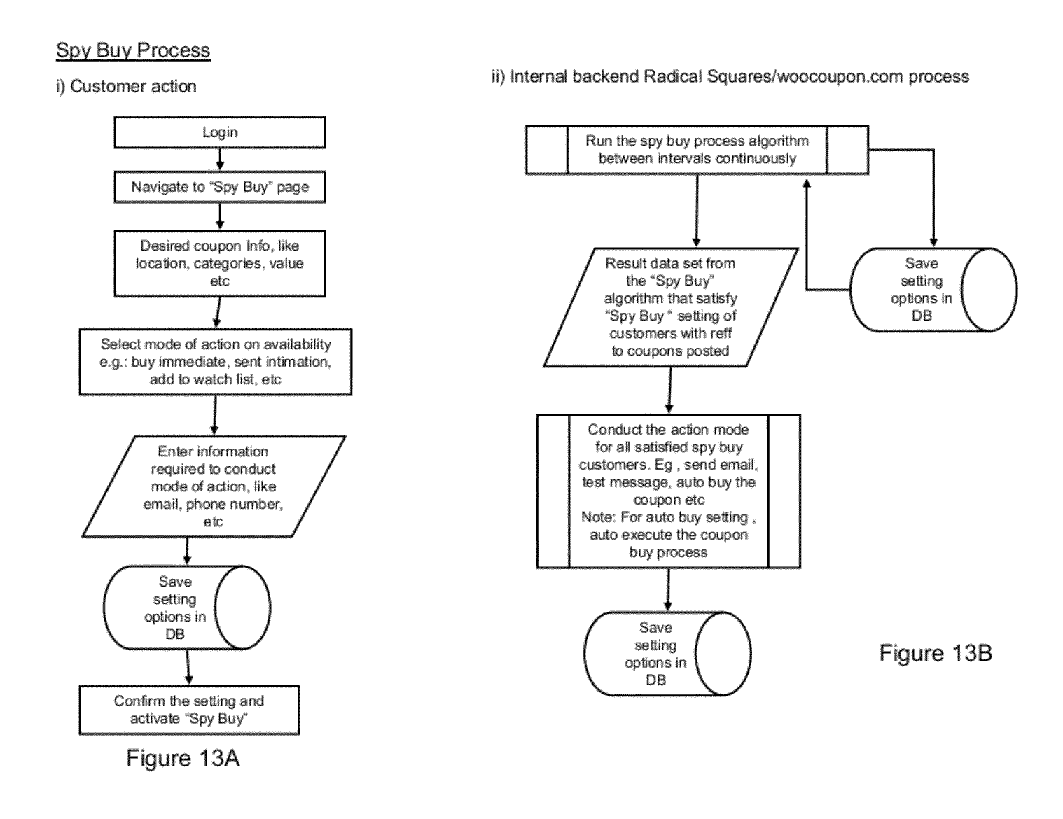

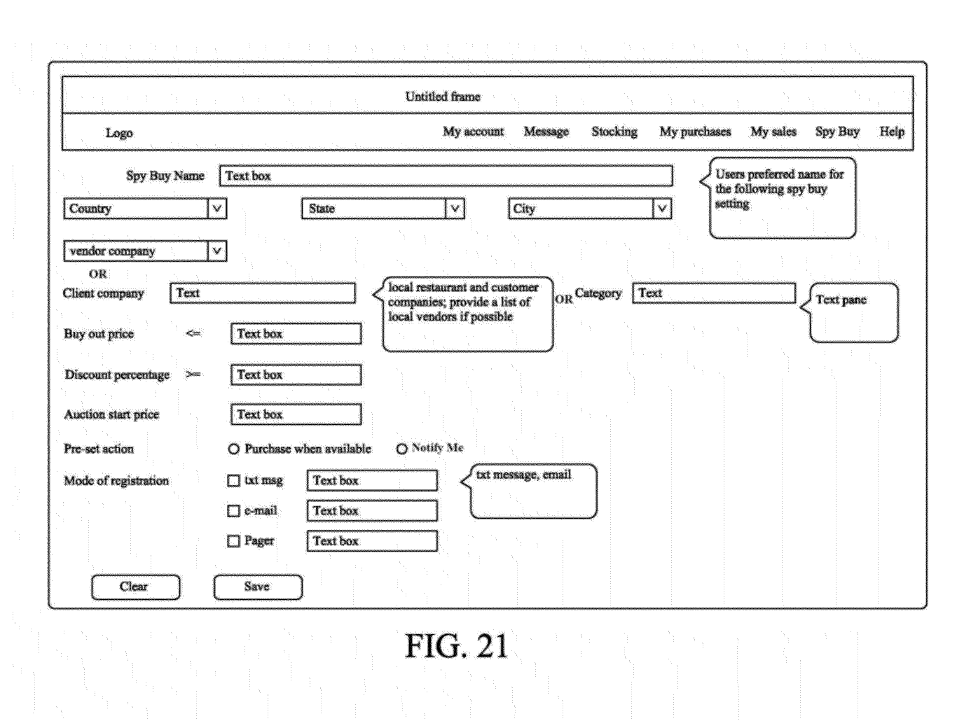

FIG. 13A illustrates customer action for a “spy buy” process in which a customer can elect to be alerted and can purchase coupons from particular clients based on predefined preference settings for that customer. The customer is doing 2 things here: 1) setting his preferences for the coupon he desired using different parameters provided (e.g., location, value, discount, etc.) and 2) setting the action to take when that group coupon is determined to be available. Generally, from a particular user interface (e.g., the one shown in FIG. 21, and in particular relating to the “Purchase when Available” option disclosed therein). FIG. 13B illustrates operation of the system to implement the “spy buy” process of FIG. 13A, and includes running a set of rules set by one or more users periodically against the list of available group coupons and taking actions (buying, prompting users to buy, etc.) with respect to each user associated with a particular triggered “spy buy” action.

FIGS. 14-21 illustrate a plurality of user interface screens capable of being generated using the methods and systems of the present disclosure.

In the preferred embodiment, the disclosed invention is computer-implemented and uses a computing system including at least one computing device. In some embodiments the computing system further includes a communication network and one or more additional computing devices (such as a server).

The computing device can be a stand-alone computing device or a networked computing device that communicates with one or more other additional computing devices across a network. The additional computing device(s) can be, for example, located remote from the initial computing device, but configured for data communication with the initial computing device across a network.

In some examples, the computing device includes at least one processor or processing unit and system memory. Depending on the exact configuration and type of computing device, the system memory may be volatile (such as RAM), nonvolatile (such as ROM, flash memory, etc.) or some combination of the two. System memory typically includes an operating system suitable for controlling the operation of the computing device, such as the WINDOWS® operating systems from Microsoft Corporation of Redmond, Wash., or a server, such as Windows SharePoint Server, also from Microsoft Corporation. The system memory may also include one or more software applications and may include program data.

The computing device may have additional features or functionality. For example, the device may also include additional data storage devices (removable and/or non-removable) such as, for example, magnetic disks, optical disks, or tape. Computer storage media may include volatile and nonvolatile, removable and non-removable media implemented in any method or technology for storage of information, such as computer readable instructions, data structures, program modules, or other data. System memory, removable storage and non-removable storage are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device. An example of computer storage media is non-transitory media.

In some examples, one or more of the computing devices can be located in a user or a vendor's place of business. In other examples, the computing device can be a personal computing device that is networked to allow the user, the vendor or the client to access the invention disclosed herein at a remote location, such as in a user's home or other location. In some embodiments, the computing device is a smart phone or other mobile device. In some embodiments some components of the disclosed invention are stored as data instructions for a smart phone application. A network facilitates communication between the computing device and one or more servers, such as an additional computing device, that host the disclosed invention. The network may be a wide variety of different types of electronic communication networks. For example, the network may be a wide-area network, such as the Internet, a local-area network, a metropolitan-area network, or another type of electronic communication network. The network may include wired and/or wireless data links. A variety of communications protocols may be used in the network including, but not limited to, Ethernet, Transport Control Protocol (TCP), Internet Protocol (IP), Hypertext Transfer Protocol (HTTP), SOAP, remote procedure call protocols, and/or other types of communications protocols.

In some examples, the additional computing device is a Web server. In this example, the initial computing device includes a Web browser that communicates with the Web server to request and retrieve data. The data is then displayed to the user, vendor or client, such as using a Web browser software application.

It is recognized that using the system of the present disclosure, a completed transaction will result in exchange of revenue of the value greater than or less than the value of the coupon and other additional charges. The exchange is done electrically though any of a number of electronic commerce methods and also more conventional methods of money order and checks. The completed transaction will issue new validated and secure coupons for the respective individual buyers, depending on the action. The individual will maintain a record of actions electronically on the hub systems through dedicated data sets. These data sets can be accessed and altered and deleted any time by users having proper authorization protocols and satisfying conditions preset in the systems disclosed herein.

Using the current invention individuals will be able to resell valid and used coupons electronically with minimal effort. It is noted that the present disclosure is useable regardless of the particular group coupon issuing entity, and can be used with a variety of different group coupon issuers. As such, the present disclosure allows users to access and purchase/resell group coupons from a variety of different entities, and manage group coupons in a single central location regardless of issuer.

Through use of the systems of the present disclosure, individuals are able to shop various group coupon providers' current offers though one unified electronic application/system over a network. This invention will also maintain individuals' trace of action like buying, reselling, selling, and funds transfer.

Additional details regarding systems and methods of the present disclosure can be found in the flowcharts and user interfaces of accompanying FIGS. 1-21. Although these Figures provide an example implementation of the present disclosure, it is recognized that various alternative embodiments are encompassed as well, for example with varying user interfaces, user interface layouts, orders of method steps, and varying tasks.

The exemplary embodiments described herein in detail for illustrative purposes are subject to many variations in structure, design and implementation. It should be emphasized that the present invention is not limited to a particular use, as shown and described. It is understood that various omissions and substitutions of equivalents are contemplated as circumstances may suggest or render expedient, but these are intended to cover the application or embodiments without departing from the spirit or scope of the present disclosure. Also, it is to be understood that the phraseology and terminology used herein are for the purpose of description and should not be regarded as limiting.

What is claimed is:

1. A method of buying and selling coupons or other voucher type items with reduced fraud comprising a network server, a microprocessor, a memory and computer software, said computer software being located in said memory and run by said microprocessor, said computer software comprising a coupon retailing algorithm, wherein said discount retailing algorithm comprises the steps of:
(a) Obtaining a coupon from a selling user who received such coupon from an issuing retailer;
(b) Validating the coupon to ensure it holds value;
(c) Placing a hold status on the coupon so it cannot be redeemed and communicating the same to the issuing retailer;
(d) Displaying the coupon for sale electronically;
(e) Allowing a buying user to locate and then purchase the coupon;
(f) Assigning a new valid coupon code to the coupon upon its purchase; and
(g) Communicating the new valid coupon code to the issuing retailer.

2. The method of claim 1, wherein the coupon is displayed for sale in an auction setting.

3. The method of claim 1, wherein the coupon can be printed by the buying user after purchase.
